(19) United States
(12) Patent Application Publication
(10) Pub. No.: US 2018/0223099 A1
(43) Pub. Date: Aug. 9, 2018

(54) PELLET AND PROCESS FOR PRODUCING THE SAME

(71) Applicant: ASAHI KASEI KABUSHIKI KAISHA, Tokyo (JP)

(72) Inventors: Nozomi INAGAKI, Tokyo (JP); Mihoko YAMAMOTO, Tokyo (JP)

(73) Assignee: ASAHI KASEI KABUSHIKI KAISHA, Tokyo (JP)

(21) Appl. No.: 15/425,044

(22) Filed: Feb. 6, 2017

(51) Int. Cl. C08L 71/12; B29B 9/10; B29B 7/48; B29C 45/00

(52) U.S. Cl. CPC C08L 71/123; B29B 9/10; B29K 2071/12; B29C 45/0001; B29B 7/484

(57) ABSTRACT

Provided is a pellet that contains a polyphenylene ether resin in a high concentration, is highly suitable for use as a modifier for imparting creep resistance, and has excellent post-molding external appearance. The pellet contains 80 mass % to 99 mass % of a polyphenylene ether resin (I) and 1 mass % to 20 mass % of a hydrogenated block copolymer (II) that is an at least partially hydrogenated product of a block copolymer including a polymer block P of mainly a vinyl aromatic compound and a polymer block Q of mainly a conjugated diene compound in which the total of 1,2-vinyl bond content and 3,4-vinyl bond content is 50% to 95%. No black spot contaminants having a major diameter of greater than 0.7 mm are present on front and rear surfaces of four plates of 90.0 mm×50.0 mm×2.0 mm in size obtained through molding of the pellet.

### TECHNICAL FIELD

This disclosure relates to a pellet and a process for producing this pellet.

### BACKGROUND

Polyphenylene ethers are resins that are suitable for various applications such as automobile applications and OA (office automation) applications due to having characteristics such as heat resistance, excellent electrical properties, low specific gravity, and so forth. However, polyphenylene ethers have poor molding workability when used on their own and are, therefore, often used in the form of an alloy with another resin.

One known example of such an alloy is an alloy that is obtained by adding a small amount of a polyphenylene ether to another resin and that is used as a modifier for polyolefin resins, and particularly polypropylene resins (refer to PTL 1).

However, when the modifier in PTL 1 containing a small amount of a polyphenylene ether is used in a polyolefin resin (particularly a polypropylene resin) or the like, there is an issue that equipment needs to be adapted to suppress vent-up of powder-form polyphenylene ether from an atmospheric release barrel and lower the risk of dust explosion. Moreover, it may not be possible to uniformly disperse the polyphenylene ether in a polyolefin resin or the like due to the low content of the polyphenylene ether. Consequently, there are cases in which adequate performance in terms of creep behavior is not displayed.

### CITATION LIST

### Patent Literature

PTL 1: Japanese Patent No. 5622905

### SUMMARY

There is a need for a polyphenylene ether to be contained in another resin in a high concentration for the purpose of modifying resins such as polyolefin resins. However, production of a composition containing a polyphenylene ether in a high concentration is associated with problems such as poor production efficiency and the formation of black spot contaminants originating from the polyphenylene ether.

PTL 1 describes a resin composition that contains a polyphenylene ether in a low concentration and that has excellent external appearance and production efficiency, but does not consider a situation in which a polyphenylene ether is contained in a high concentration.

The present disclosure is made in response to the technical problems described above and provides a pellet that contains a polyphenylene ether resin in a high concentration and has excellent external appearance. The present disclosure also provides a process for efficiently producing a pellet that contains a polyphenylene ether resin in a high concentration and has excellent external appearance.

Diligent investigation conducted with the aim of solving the problems set forth above resulted in the discovery that these problems can be beneficially solved through a pellet that contains a polyphenylene ether and a hydrogenated block copolymer having a specific structure, and that limits black spot contaminants to no greater than a specific amount. This discovery led to the present disclosure.

Specifically, the present disclosure provides the following.

[1] A pellet comprising:

80 mass % to 99 mass % of a polyphenylene ether resin (I); and

1 mass % to 20 mass % of a hydrogenated block copolymer (II) that is an at least partially hydrogenated product of a block copolymer including a polymer block P of mainly a vinyl aromatic compound and a polymer block Q of mainly a conjugated diene compound in which the total of 1,2-vinyl bond content and 3,4-vinyl bond content is 50% to 95%, wherein no black spot contaminants having a major diameter of greater than 0.7 mm are present on front and rear surfaces of four plates of 90.0 mm×50.0 mm×2.0 mm in size obtained through molding of the pellet.

[2] The pellet according to [1], wherein

the number of black spot contaminants having a major diameter of greater than 0.5 mm and no greater than 0.7 mm that are present on the front and rear surfaces of the four plates is no greater than 5.

[3] The pellet according to [1] or [2], wherein

the number of black spot contaminants having a major diameter of greater than 0.3 mm and no greater than 0.5 mm that are present on the front and rear surfaces of the four plates is no greater than 10.

[4] The pellet according to any one of [1] to [3], comprising:

90 mass % to 99 mass % of the polyphenylene ether resin (I); and

1 mass % to 10 mass % of the hydrogenated block copolymer (II).

[5] The pellet according to any one of [1] to [4], wherein

the polymer block P has a number average molecular weight of at least 15,000.

[6] The pellet according to any one of [1] to [5], wherein

the total of 1,2-vinyl bond content and 3,4-vinyl bond content of the conjugated diene compound in the polymer block Q is 70% to 95%.

[7] A process for producing a pellet, comprising

melt-kneading by a twin screw extruder of a mixture containing: 80 mass % to 99 mass % of a polyphenylene ether resin (I); and 1 mass % to 20 mass % of a hydrogenated block copolymer (II) that is an at least partially hydrogenated product of a block copolymer including a polymer block P of mainly a vinyl aromatic compound and a polymer block Q of mainly a conjugated diene compound in which the total of 1,2-vinyl bond content and 3,4-vinyl bond content is 50% to 95%, wherein

oxygen concentration inside a raw material feeding hopper that is furthest upstream in terms of a direction of mixture flow in the twin screw extruder is less than 3 volume %.

[8] The process for producing a pellet according to [7], wherein

the twin screw extruder includes:

a first kneading zone and a second kneading zone; and

at least two vents located between the first kneading zone and the second kneading zone, or further downstream than the second kneading zone, and

at least one of the vents is an atmospheric release vent for gas venting.

[9] The process for producing a pellet according to [8], wherein

a screw of the first kneading zone includes at least one orthogonal screw element and does not include a compression screw element.

[10] The process for producing a pellet according to [8] or [9], wherein

a screw of the second kneading zone includes at least one compression screw element.

[11] The process for producing a pellet according to any one of [8] to [10], wherein

the atmospheric release vent for gas venting is filled with an inert gas.

[12] The process for producing a pellet according to any one of [8] to [11], wherein

a barrel temperature of at least 300° C. is set from a furthest upstream barrel in terms of the direction of mixture flow in the twin screw extruder, to a barrel at which the atmospheric release vent for gas venting is located.

[13] A resin modifier comprising the pellet according to any one of [1] to [6].

[14] A thermoplastic resin composition comprising the resin modifier according to [13].

According to the present disclosure, it is possible to provide a pellet that contains a polyphenylene ether resin in a high concentration and has excellent external appearance. Moreover, the presently disclosed pellet is capable of modifying a thermoplastic resin such as a polypropylene resin.

Furthermore, through the presently disclosed production process, it is possible to provide a process for efficiently producing a pellet that contains a polyphenylene ether resin in a high concentration and has excellent external appearance. The presently disclosed production process enables production of a pellet capable of modifying a thermoplastic resin such as a polypropylene resin.

### BRIEF DESCRIPTION OF THE DRAWING

In the accompanying drawing,

FIG. 1 is a schematic plan-view illustrating the shape of a test piece used to evaluate modifying performance with respect to a polypropylene resin.

### DETAILED DESCRIPTION

The following provides a detailed description of an embodiment of this disclosure (hereinafter, referred to as “the present embodiment”). However, the present disclosure is not limited to the embodiment set forth below and can be implemented with various alterations within the essential scope thereof.

[Pellet] A pellet of the present embodiment contains 80 mass % to 99 mass % of a polyphenylene ether resin (I) and 1 mass % to 20 mass % of a hydrogenated block copolymer (II), and may optionally further contain a thermoplastic resin (III) other than the components (I) and (II), and an additive (IV) other than the components (I) to (III).

The pellet of the present embodiment is preferably a reinforced flame retardant pellet.

The polyphenylene ether resin (I) may also be referred to as “component (I)” in the present specification. Likewise, the hydrogenated block copolymer (II) may also be referred to as “component (II)”.

The components of the pellet of the present embodiment are described below.

(Polyphenylene ether resin (I))

Examples of the polyphenylene ether resin (I) used in the present embodiment include, but are not specifically limited to, polyphenylene ethers, modified polyphenylene ethers, and mixtures thereof. One component (I) may be used individually, or two or more components (I) may be used in combination.

From a viewpoint of further improving modifying performance, the reduced viscosity of the polyphenylene ether resin (I) is preferably at least 0.25 dL/g, and more preferably at least 0.28 dL/g, and is preferably no greater than 0.55 dL/g, more preferably no greater than 0.53 dL/g, and particularly preferably no greater than 0.50 dL/g. The reduced viscosity can be controlled through the polymerization time, the amount of catalyst, and so forth.

The reduced viscosity (η_{red}) can be determined by measuring a chloroform solution adjusted to 0.5 g/dL at 30° C. using an Ubbelohde viscometer and by dividing the specific viscosity ηₛₚ by the concentration c (g/dL) according to the following formula.

η_{red}=ηₛₚ/c

From a viewpoint of reducing the number of black spot contaminants in the pellet, the degree of crosslinking of the polyphenylene ether resin (I) is preferably 0 mass % to 0.3 mass %, and more preferably 0 mass % to 0.1 mass %.

The degree of crosslinking can be measured by the following method.

The mass A (mg) of approximately 200 mg of the polyphenylene ether resin (I) is weighed. Next, the specimen is immersed in 20 mL of chloroform and is subjected to ultrasound vibration for 6 hours. Thereafter, soluble matter and insoluble matter are separated by suction filtration. The resultant residue (insoluble matter) is vacuum dried for 2 hours at 100° C. and then the mass B (mg) of the insoluble component is weighed. The degree of crosslinking (units: mass %) is calculated according to the following formula, based on the obtained masses A and B.

Degree of crosslinking (mass %)=100×(B/A)

—Polyphenylene Ether—

Examples of the polyphenylene ether include, but are not specifically limited to, a homopolymer composed by a repeating unit represented by the following formula (1) and a copolymer including a repeating unit represented by the following formula (1).

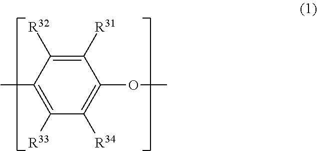

[In formula (1), R³¹, R³², R³³, and R³⁴ are each, independently of one another, a monovalent group selected from the group consisting of a hydrogen atom, a halogen atom, a primary alkyl group having a carbon number of 1 to 7, a secondary alkyl group having a carbon number of 1 to 7, a phenyl group, a haloalkyl group, an aminoalkyl group, an oxyhydrocarbon group, and an oxyhalohydrocarbon group in which a halogen atom and an oxygen atom are separated by at least two carbon atoms.]

Commonly known polyphenylene ethers can be used as the polyphenylene ether set forth above without any specific limitations. Specific examples of polyphenylene ethers that can be used include homopolymers such as poly(2,6-dimethyl-1,4-phenylene ether), poly(2-methyl-6-ethyl-1,4-phenylene ether), poly(2-methyl-6-phenyl-1,4-phenylene ether), and poly(2,6-dichloro-1,4-phenylene ether); and copolymers such as a copolymer of 2,6-dimethylphenol and another phenol (for example, 2,3,6-trimethylphenol or 2-methyl-6-butylphenol). It is preferable that poly(2,6-dimethyl-1,4-phenylene ether) or a copolymer of 2,6-dimethylphenol and 2,3,6-trimethylphenol is used, and more preferable that poly(2,6-dimethyl-1,4-phenylene ether) is used.

Conventional and commonly known processes may be used as the production process of the polyphenylene ether without any specific limitations. Specific examples of processes by which the polyphenylene ether can be produced include a process described in U.S. Pat. No. 3,306,874 in which a complex of a cuprous salt and an amine is used as a catalyst to perform oxidative polymerization of 2,6-xylenol or the like, and processes described in U.S. Pat. Nos. 3,306,875, 3,257,357, and 3,257,358, Japanese Examined Patent Application Publication No. S52-17880, and Japanese Unexamined Patent Application Publication Nos. S50-51197 and S63-152628.

—Modified Polyphenylene Ether—

The modified polyphenylene ether may be, but is not specifically limited to, a product of grafting or addition of a styrene polymer or derivative thereof to the above-described polyphenylene ether. Although the proportion of mass increase due to grafting or addition is not specifically limited, the mass increase relative to 100 mass % of the modified polyphenylene ether is preferably at least 0.01 mass %, and is preferably no greater than 10 mass %, more preferably no greater than 7 mass %, and particularly preferably no greater than 5 mass %.

The process by which the modified polyphenylene ether is produced may be, but is not specifically limited to, a process in which the polyphenylene ether and the styrene polymer or derivative thereof are reacted in a molten, solution, or slurry state at 80° C. to 350° C., either with or without a radical generator present.

In a situation in which a mixture of a polyphenylene ether and a modified polyphenylene ether is used as the polyphenylene ether resin (I) in the present embodiment, the mixing ratio of the polyphenylene ether and the modified polyphenylene ether may be freely selected without any specific limitations.

(Hydrogenated Block Copolymer (II))

Examples of the hydrogenated block copolymer (II) used in the present embodiment include, but are not specifically limited to, unmodified hydrogenated block copolymers, modified hydrogenated block copolymers, and mixtures thereof. One component (II) may be used individually, or two or more components (II) may be used in combination.

The component (II) serves as a compatibilizer for the component (I) and another resin, such as a polyolefin resin.

The hydrogenated block copolymer (II) is an at least partially hydrogenated product of a block copolymer including a polymer block P of mainly a vinyl aromatic compound and a polymer block Q of mainly a conjugated diene compound in which the total of 1,2-vinyl bond content and 3,4-vinyl bond content is 50% to 95%.

The following describes the unmodified and modified hydrogenated block copolymers.

—Unmodified Hydrogenated Block Copolymer—

### —Polymer Block P of Mainly Vinyl Aromatic Compound—

Examples of the polymer block P of mainly a vinyl aromatic compound include, but are not specifically limited to, a homopolymer block of a vinyl aromatic compound, and a copolymer block of a vinyl aromatic compound and a conjugated diene compound.

Note that when the polymer block P is referred to as being “of mainly a vinyl aromatic compound”, this means that in the polymer block P, the content of constitutional units derived from a vinyl aromatic compound is greater than 50 mass %. The content of these constitutional units is preferably at least 70 mass %, and more preferably at least 80 mass %, and may be 100 mass % or less.

Examples of vinyl aromatic compounds that can be used to form the polymer block P include, but are not specifically limited to, styrene, α-methylstyrene, vinyltoluene, p-tert-butylstyrene, and diphenylethylene, of which, styrene is preferable. One vinyl aromatic compound may be used individually, or two or more vinyl aromatic compounds may be used in combination.

From a viewpoint of improving modifying performance, the number average molecular weight (Mn) of the polymer block P is preferably at least 15,000, more preferably at least 20,000, and particularly preferably at least 25,000, and is preferably no greater than 100,000.

Number average molecular weights (Mn) and weight average molecular weights (Mw) described in the present specification can be determined by GPC (mobile phase: chloroform; reference material: polystyrene) according to a conventional and commonly known method.

—Polymer Block Q of Mainly Conjugated Diene Compound—

Examples of the polymer block Q of mainly a conjugated diene compound include, but are not specifically limited to, a homopolymer block of a conjugated diene compound, and a copolymer block of a conjugated diene compound and a vinyl aromatic compound.

Note that when the polymer block Q is referred to as being “of mainly a conjugated diene compound”, this means that in the polymer block Q, the content of constitutional units derived from a conjugated diene compound is greater than 50 mass %. From a viewpoint of raising the fluidity of the pellet, the content of these constitutional units is preferably at least 70 mass %, and more preferably at least 80 mass %, and may be 100 mass % or less.

Examples of conjugated diene compounds that may be used to form the polymer block Q include butadiene, isoprene, 1,3-pentadiene, 2,3-dimethyl-1,3-butadiene, and combinations thereof. It is preferable that butadiene, isoprene, or a combination thereof is used, and more preferable that butadiene is used. One conjugated diene compound may be used individually, or two or more conjugated diene compounds may be used in combination.

From a viewpoint of making it easier to impart creep resistance on a thermoplastic resin, such as polypropylene, the total of 1,2-vinyl bond content and 3,4-vinyl bond content in the conjugated diene compound is at least 50%, preferably at least 60%, and more preferably at least 70%, and is no greater than 95%.

The “total of 1,2-vinyl bond content and 3,4-vinyl bond content” refers to the total of 1,2-vinyl bond content and 3,4-vinyl bond content expressed as a proportion of the total of 1,2-vinyl bond content, 3,4-vinyl bond content, and 1,4-conjugated bond content. The vinyl bond content can be calculated in accordance with the method described in Analytical Chemistry, Volume 21, No. 8, August 1949, through measurement using an infrared spectrophotometer.

From a viewpoint of improving modifying performance, the number average molecular weight (Mn) of the polymer block Q is preferably at least 20,000, more preferably at least 25,000, and particularly preferably at least 30,000, and is preferably no greater than 100,000.

The block copolymer including the polymer block P and the polymer block Q can be synthesized by a commonly known method such as anionic polymerization, but is not specifically limited thereto.

Examples of the block structure of the block copolymer including the polymer block P and the polymer block Q include, but are not specifically limited to, P-Q, P-Q-P, Q-P-Q-P, (P-Q-)₄M, and P-Q-P-Q-P structures, where “P” represents the polymer block P and “Q” represents the polymer block Q. (P-Q-)₄M is a reaction residue of a polyfunctional coupling agent such as silicon tetrachloride (M=Si) or tin tetrachloride (M=Sn), a residue of an initiator such as a polyfunctional organolithium compound, or the like.

Examples of the molecular structure of the block copolymer including the polymer block P and the polymer block Q include, but are not specifically limited to, a linear structure, a branched structure, a radial structure, and combinations thereof.

No specific limitations are placed on the distribution of units derived from the vinyl aromatic compound in the chain of the polymer block P included in the block copolymer. Likewise, no specific limitations are placed on the distribution of units derived from the conjugated diene compound in the chain of the polymer block Q contained in the block copolymer. For example, these units may have a random distribution, a tapered distribution (distribution in which monomer sections increase or decrease along the chain), a partial block distribution, or a combination thereof.

In a situation in which the block copolymer includes a plurality of polymer blocks P, the polymer blocks P may have the same structure as one another or different structures. Likewise, in a situation in which the block copolymer includes a plurality of polymer blocks Q, the polymer blocks Q may have the same structure as one another or different structures.

From a viewpoint of improvement of fluidity of the hydrogenated block copolymer (II), impact resistance, and external appearance, and reduction of weld formation, the content of units derived from the vinyl aromatic compound relative to the entire block copolymer including the polymer block P and the polymer block Q is preferably at least 20 mass %, and more preferably at least 30 mass %, and is preferably no greater than 95 mass %, and more preferably no greater than 80 mass %.

The content of units derived from the vinyl aromatic compound can be measured using an ultraviolet spectrophotometer.

The number average molecular weight (Mn) of the block copolymer prior to hydrogenation is preferably at least 5,000, more preferably at least 10,000, and particularly preferably at least 30,000, and is preferably no greater than 1,000,000, more preferably no greater than 800,000, and particularly preferably no greater than 500,000.

The molecular weight distribution (Mw/Mn) of the block copolymer prior to hydrogenation is preferably no greater than 10, more preferably no greater than 8, and particularly preferably no greater than 5.

The process by which the block copolymer is hydrogenated may be, but is not specifically limited to, a process in which hydrogenation is performed under conditions of a reaction temperature of 0° C. to 200° C. and a hydrogen pressure of 0.1 MPa to 15 MPa using (1) a supported heterogeneous hydrogenation catalyst of a metal such as Ni, Pt, Pd, or Ru supported by carbon, silica, alumina, diatomaceous earth, or the like, (2) a Ziegler hydrogenation catalyst in which a transition metal salt such as an organic acid salt or acetylacetone salt of Ni, Co, Fe, Cr, or the like and a reducing agent such as an organoaluminum reducing agent are used, or (3) a homogeneous hydrogenation catalyst of an organometallic complex or the like that is an organometallic compound or the like of a metal such as Ti, Ru, Rh, or Zr.

No specific limitations are placed on the hydrogenation rate of a conjugated diene compound portion of the polymer block Q in the hydrogenated block copolymer (II). However, from a viewpoint of raising the heat resistance of the pellet, the hydrogenation rate relative to the total number of double bonds derived from the conjugated diene compound is preferably at least 50%, more preferably at least 80%, and particularly preferably at least 90%.

The hydrogenation rate can be measured using a nuclear magnetic resonance (NMR) spectrometer.

Commonly known processes may be used as the production process of the hydrogenated block copolymer (II) without any specific limitations. Specific examples of commonly known production processes that can be used include those described in Japanese Unexamined Patent Application Publication Nos. S47-11486, S49-66743, S50-75651, S54-126255, S56-10542, S56-62847, S56-100840, and H2-300218, UK Patent Nos. 1130770 and 1020720, and U.S. Pat. Nos. 3,281,383, 3,639,517, 3,333,024, and 4,501,857.

—Modified hydrogenated block copolymer—The modified hydrogenated block copolymer is a product obtained through grafting or addition of an α,β-unsaturated carboxylic acid or a derivative thereof (for example, an acid anhydride or an ester) to the unmodified hydrogenated block copolymer described above.

Although the proportion of mass increase due to grafting or addition is not specifically limited, the mass increase relative to 100 mass % of the modified hydrogenated block copolymer is preferably at least 0.01 mass %, and is preferably no greater than 10 mass %, more preferably no greater than 7 mass %, and particularly preferably no greater than 5 mass %.

The process by which the modified hydrogenated block copolymer is produced may be, but is not specifically limited to, a process in which the unmodified hydrogenated block copolymer is reacted with the α,β-unsaturated carboxylic acid or derivative thereof in a molten, solution, or slurry state at 80° C. to 350° C., either with or without a radical generator present.

(Thermoplastic Resin (III) Other than Components (I) and (II))

Examples of thermoplastic resins (III), other than the components (I) and (II), that may optionally be used in the present embodiment include, but are not specifically limited to, polystyrene, syndiotactic polystyrene, and high impact polystyrene.

(Additive (IV) Other than Components (I) to (III))

Examples of additives (IV), other than the components (I) to (III), that may optionally be used in the present embodiment include, but are not specifically limited to, a block copolymer of a vinyl aromatic compound and a conjugated diene compound; an olefinic elastomer, a fluorine-containing polymer; a plasticizer such as low molecular weight polyethylene, epoxidized soybean oil, polyethylene glycol, or a fatty acid ester; a flame retardant such as an alkyl metal phosphinate compound, melamine pyrophosphate, melamine polyphosphate, a phosphoric acid ester compound, an ammonium polyphosphate compound, magnesium hydroxide, an aromatic halogen-containing flame retardant, a silicone flame retardant, or zinc borate; a flame retardant aid such as antimony trioxide; an organic or inorganic filler; an organic or inorganic reinforcer such as carbon black, titanium oxide, calcium carbonate, mica, kaolin, glass fiber, glass flake, conductive carbon black, talc, or wollastonite; an antioxidant; a metal deactivator; a heat stabilizer; a weather (light) resistance modifier; a nucleating agent for a polyolefin; a slip agent; a colorant; and a mold release agent.

The proportions of components in the pellet of the present embodiment are described below.

From a viewpoint of raising modifying performance, the content of the component (I) in the pellet of the present embodiment, relative to the entire pellet, is at least 80 mass %, preferably at least 85 mass %, and more preferably at least 90 mass %, and is no greater than 99 mass %, preferably no greater than 98 mass %, and more preferably no greater than 97 mass %.

Moreover, from a viewpoint of raising modifying performance, the content of the component (II) in the pellet of the present embodiment, relative to the entire pellet, is at least 1 mass %, more preferably at least 2 mass %, and particularly preferably at least 3 mass %. Furthermore, from a viewpoint of inhibiting detachment from the pellet, the content of the component (II) in the pellet of the present embodiment, relative to the entire pellet, is no greater than 20 mass %, more preferably no greater than 15 mass %, and particularly preferably no greater than 10 mass %.

The content of each of the components (III) and (IV) in the pellet of the present embodiment is not specifically limited so long as the effects disclosed herein are not lost. For example, the content relative to the entire pellet (100 parts by mass) may be 0 parts by mass to 400 parts by mass.

—Number of Black Spot Contaminants—

No black spot contaminants having a major diameter of greater than 0.7 mm are observed on front and rear surfaces of fours plates of 90.0 mm×50.0 mm×2.0 mm in size (total number of surfaces: 8; total area: 36,000 mm²) obtained through molding of the presently disclosed pellet.

The number of black spot contaminants having a major diameter of greater than 0.5 mm and no greater than 0.7 mm that are observed on the front and rear surfaces of the four plates is preferably no greater than 5, and more preferably no greater than 3.

The number of black spot contaminants having a major diameter of greater than 0.3 mm and no greater than 0.5 mm that are observed on the front and rear surfaces of the four plates is preferably no greater than 10, and more preferably no greater than 6.

The term “black spot contaminants” refers to black spot contaminants that are formed through progression of crosslinking when a polyphenylene ether resin undergoes long-term exposure to high temperatures or exposure to oxygen at high temperatures.

The number of black spot contaminants can be measured by the method described in “(1) Major diameter and number of black spot contaminants” of the EXAMPLES section further below. The term “major diameter” refers to the maximum diameter of a black spot contaminant in plan-view.

In order to limit the number of these contaminants to the ranges set forth above, it is necessary to control the production process as described below.

The pellet of the present embodiment can be produced by the subsequently described process for producing a pellet.

When the pellet of the present embodiment is mixed with a polyolefin resin or the like, the pellet can impart creep resistance, heat resistance, and so forth to the resin as a result of containing a polyphenylene ether in a high concentration.

The pellet of the present embodiment is suitable for modification applications (for example, imparting creep resistance and heat resistance) with respect to thermoplastic resins (particularly polyolefin resins). The resultant modified resin can be used for automobile parts, interior and exterior parts of electrical equipment, various other parts, and so forth.

Examples of automobile parts include, but are not specifically limited to, exterior parts such as bumpers, fenders, door panels, various moldings, emblems, engine hoods, wheel caps, roofs, spoilers, and various aero parts; interior parts such as instrument panels, console boxes, and trims; secondary battery container parts incorporated into a vehicle, electric vehicle, hybrid electric vehicle, or the like; and lithium ion secondary battery parts.

Examples of interior and exterior parts of electrical equipment include, but are not specifically limited to, parts used in various computers and peripherals thereof, other OA equipment, televisions, videos, cabinets of various disc players and the like, chassis, refrigerators, air conditioners, and liquid-crystal projectors.

Examples of other parts include electrical wires and cables obtained through coating of a metal conductor or optical fiber, fuel cases for solid methanol fuel cells, fuel cell water pipes, water cooling tanks, boiler outer cases, ink peripheral parts and components of inkjet printers, furniture (chairs, etc.), chassis, water pipes, and joints.

[Process for Producing Pellet]

The process by which the pellet of the present embodiment is produced may, for example, be a process in which a twin screw extruder is used to melt-knead a mixture containing 80 mass % to 99 mass % of a polyphenylene ether resin (I) and 1 mass % to 20 mass % of a hydrogenated block copolymer (II) that is an at least partially hydrogenated product of a block copolymer including a polymer block P of mainly a vinyl aromatic compound and a polymer block Q of mainly a conjugated diene compound in which the total of 1,2-vinyl bond content and 3,4-vinyl bond content is 50% to 95%. In this production process, the oxygen concentration inside a raw material feeding hopper that is furthest upstream in terms of a direction of mixture flow in the twin screw extruder is preferably less than 3 volume %.

The mixture in the production process of the present embodiment can be produced by mixing the above-described components (I) and (II), and also the above-described components (III) and (IV) as necessary.

Examples of devices that can be used to perform the melt-kneading include a single screw kneading extruder, a multi-screw kneading extruder, a roller, and a Banbury mixer. Of these devices, a twin screw extruder is preferable, and a twin screw extruder including a pressure reducing device is particularly preferable. Specific examples of twin screw extruders that can be used include the ZSK series produced by Coperion GmbH, the TEM series produced by Toshiba Machine Co., Ltd., and the TEX series produced by The Japan Steel Works, Ltd.

The method of melt-kneading may, for example, be a method in which all the components are melt-kneaded simultaneously or a method in which a mixture prepared by pre-mixing is melt-kneaded.

To eliminate black spot contaminants that may be present after molding of the pellet, it is preferable that one or more of configurations (a) to (h), shown below, are adopted in relation to screw configuration and vent position in melt-kneading of the resin composition by the twin screw extruder.

(a) The oxygen concentration inside a furthest upstream powder raw material feeding/collection hopper of the twin screw extruder is less than 3 volume %.

(b) A single flight screw zone for which L/D (screw axial direction length/screw diameter) is 4.5 to 20 is included.

(c) A double flight screw zone for which L/D is 4 to 20 is included downstream relative to the single flight screw zone.

(d) A first kneading zone including two orthogonal screw elements and not including a compression screw element is included downstream relative to the double flight screw zone (relative to a double flight screw zone that is furthest upstream in terms of the direction of mixture flow in a situation in which two or more double flight screw zones are included), and L/D of this first kneading zone is 3 to 8.

(e) An atmospheric gas vent or a vacuum vent is included downstream relative to the first kneading zone.

(f) A second kneading zone including at least one compression screw element is included downstream relative to the atmospheric gas vent or vacuum vent, and L/D of this second kneading zone is 3 to 12.

(g) The atmospheric gas vent is filled with an inert gas.

(h) A vacuum vent is included downstream relative to the second kneading zone.

Note that a solid conveyance zone, first kneading zone, second kneading zone, single flight screw zone, and double flight screw zone may be set in units of barrels.

From a viewpoint of reducing black spot contaminants in the obtained pellet, it is preferable that a vent port positioned downstream of the first kneading zone is an atmospheric gas vent (atmospheric release vent for gas venting) and that an inert gas is supplied to this section.

The barrel temperature setting of the twin screw extruder may, for example, be selected from temperatures in a range of 250° C. to 350° C. However, from a viewpoint of ensuring stable production, it is preferable that a temperature of at least 300° C. is set in a section from a furthest upstream point of the twin screw extruder to the vent port located downstream of the first kneading zone.

Moreover, in a situation in which an atmospheric release vent for gas venting is included, it is preferable from a viewpoint of ensuring stable production that a temperature of at least 300° C. is set from a furthest upstream barrel in terms of the direction of mixture flow in the twin screw extruder, to a barrel at which the atmospheric release vent for gas venting is located.

The twin screw extruder that is used preferably includes a first kneading zone and a second kneading zone. Moreover, from viewpoint of improving productivity, it is preferable that the twin screw extruder that is used includes at least two vents between the first kneading zone and the second kneading zone, and/or further downstream than the second kneading zone, and that at least one of these vents is an atmospheric release vent for gas venting. From a viewpoint of reducing black spot contaminants in the pellet, it is preferable that the atmospheric release vent for gas venting is filled with an inert gas such as nitrogen.

Moreover, it is preferable from a viewpoint of improving productivity and reducing black spot contaminants that the twin screw extruder that is used is a twin screw extruder in which a screw of the first kneading zone includes at least one orthogonal screw element and does not include a compression screw element.

Furthermore, it is preferable from a viewpoint of improving kneading efficiency that the twin screw extruder that is used is a twin screw extruder in which a screw of the second kneading zone includes at least one compression screw element.

The following describes a preferable embodiment in which an extruder such as a single screw extruder, twin screw extruder, other multi-screw extruder, or the like is used.

The type, specifications, and so forth of the extruder may be any commonly known examples thereof without any specific limitations.

L/D (barrel effective length/barrel internal diameter) of the extruder is preferably at least 30, and more preferably at least 40, and is preferably no greater than 75, and more preferably no greater than 60.

The screw rotation speed is normally 100 rpm to 1200 rpm, but is not specifically limited to this range.

In a situation in which a liquid-form raw material is to be added, a liquid addition pump or the like in a cylinder section of the extruder can be used to add the liquid-state raw material by direct feeding into the cylinder. The liquid addition pump may be, but is not specifically limited to, a gear pump or a flange pump, and is preferably a gear pump. From a viewpoint of reducing the load on the liquid pump and raising operability of the raw material in this situation, it is preferable that the viscosity of the liquid-form raw material is reduced in advance by using a heater or the like to heat a section that forms a flow path for the liquid-form raw material, such as a tank in which the liquid-form raw material is stored, a pipe between the tank and the liquid addition pump, or a pipe between the pump and the cylinder of the extruder.

The pellet of the present embodiment is highly suitable for use as a resin modifier. A presently disclosed resin modifier is formed from the pellet of the present embodiment and may further contain other components.

The resin modifier of the present embodiment can impart creep resistance, heat resistance, and so forth on thermoplastic resins, such as polypropylene and other polyolefin resins, and can thereby modify the properties of these resins.

A presently disclosed thermoplastic resin composition contains the resin modifier of the present embodiment. Examples of other components that may be contained in the thermoplastic resin composition include a thermoplastic resin such as a polyolefin resin (for example, polypropylene) or polystyrene; a block copolymer of a vinyl aromatic compound and a conjugated diene compound, an olefinic elastomer, an antioxidant, a metal deactivator, a heat stabilizer, a flame retardant (for example, an ammonium polyphosphate compound, a melamine polyphosphate compound, magnesium hydroxide, an aromatic halogen-containing flame retardant, a silicone flame retardant, or zinc borate), a fluorine-containing polymer, a plasticizer (for example, low molecular weight polyethylene, epoxidized soybean oil, polyethylene glycol, or a fatty acid ester), a flame retardant aid such as antimony trioxide, a weather (light) resistance modifier, a nucleating agent for a polyolefin, a slip agent, an organic or inorganic filler or reinforcer (for example, GF, long-fiber GF, CF, long-fiber CF, polyacrylonitrile fiber, carbon black, titanium oxide, calcium carbonate, conductive metal fiber, or conductive carbon black), a colorant, and a mold release agent.

The content of the resin modifier relative to the total amount (100 mass %) of the thermoplastic resin composition of the present embodiment is preferably 0.5 mass % to 50 mass %.

The thermoplastic resin composition of the present embodiment can be produced, for example, by mixing and melt-kneading a thermoplastic resin and the resin modifier of the present embodiment.

As a result of a resin modifier containing a polyphenylene ether resin in a high concentration being used in the thermoplastic resin composition of the present embodiment, the thermoplastic resin composition can reduce the likelihood of a dust explosion of the polyphenylene ether resin occurring from an atmospheric release barrel and enable the polyphenylene ether resin to be uniformly dispersed to impart creep resistance more easily than in a situation in which production is carried out using a polyphenylene ether resin powder.

The thermoplastic resin composition of the present embodiment has excellent creep resistance. Therefore, the thermoplastic resin composition can be used for automobile parts, interior and exterior parts of electrical equipment, and various other parts. Examples of these automobile parts, interior and exterior parts of electrical equipment, and other parts include the same examples as listed above.

### Examples

The following describes the present embodiment of this disclosure through examples. However, the present disclosure is not limited to the following examples.

Raw materials used for pellets in the examples and comparative examples were as follows. —Polyphenylene Ether Resin (I)—

(I-i) Polyphenylene ether obtained through oxidative polymerization of 2,6-xylenol and having a reduced viscosity (ηₛₚ/c: 0.50 g/dL chloroform solution) of 0.33 (product name: XYRON S201A; produced by Asahi Kasei Chemicals Corporation)

(I-ii) Polyphenylene ether obtained through oxidative polymerization of 2,6-xylenol and having a reduced viscosity (ηₛₚ/c: 0.50 g/dL chloroform solution) of 0.42 (product name: XYRON S202A; produced by Asahi Kasei Chemicals Corporation)

Note that the reduced viscosity ηₛₚ/c was measured at a temperature of 30° C. using a 0.5 g/dL chloroform solution.

—Hydrogenated Block Copolymer (II)—

Block copolymers were synthesized using polystyrene (homopolymer) for polymer blocks P and polybutadiene (homopolymer) for polymer blocks Q. The synthesized block copolymers were then hydrogenated by a commonly known method. Polymer modification was not carried out. The physical properties of the unmodified hydrogenated block copolymers that were obtained are shown below.

(II-i) Q-P-Q-P

Number average molecular weight (Mn) of polystyrene blocks: 41,800

Number average molecular weight (Mn) of polybutadiene blocks: 53,200

Polystyrene content of block copolymer prior to hydrogenation: 44%

Number average molecular weight (Mn) of block copolymer prior to hydrogenation: 95,000

Molecular weight distribution (Mw/Mn) of block copolymer prior to hydrogenation: 1.06

Total vinyl bond content (1,2-vinyl bond content) in polybutadiene blocks prior to hydrogenation: 75%

Hydrogenation rate of polybutadiene sections composing polybutadiene blocks: 99.9%

(II-x) P-Q-P-Q

Number average molecular weight (Mn) of polystyrene blocks: 46,800 Number average molecular weight (Mn) of polybutadiene blocks: 38,000

Polystyrene content of block copolymer prior to hydrogenation: 60% Number average molecular weight (Mn) of block copolymer prior to hydrogenation: 53,500

Molecular weight distribution (Mw/Mn) of block copolymer prior to hydrogenation: 1.20

Total vinyl bond content (1,2-vinyl bond content) in polybutadiene blocks prior to hydrogenation: 36%

Hydrogenation rate of polybutadiene sections composing polybutadiene blocks: 99.9%

The polystyrene content was measured using an ultraviolet spectrophotometer. The number average molecular weight (Mn) was determined by GPC (mobile phase: chloroform; reference material: polystyrene) according to a conventional and commonly known method. The molecular weight distribution (Mw/Mn) was calculated by dividing the weight average molecular weight (Mw), determined by GPC (mobile phase: chloroform; reference material: polystyrene) according to a conventional and commonly known method, by the number average molecular weight (Mn). The total vinyl bond content was calculated in accordance with the method described in Analytical Chemistry, Volume 21, No. 8, August 1949, through measurement using an infrared spectrophotometer. The hydrogenation rate was measured using a nuclear magnetic resonance (NMR) spectrometer.

Methods used for measuring physical properties in the examples and comparative examples were as follows.

(1) Major Diameter and Number of Black Spot Contaminants

An obtained pellet was fed into a small-size injection molding machine (product name: IS-100GN; produced by Toshiba Machine Co., Ltd.) set to a cylinder temperature of 320° C. and was molded under conditions of a mold temperature of 90° C. and an injection pressure of 60 MPa to obtain a plate test piece of 90.0 mm×50.0 mm×2.0 mm. The front and rear surfaces of four plate test pieces obtained in this manner (i.e., 8 surfaces in total) were observed by eye and the major diameter and number of black spot contaminants were measured using a scale.

The external appearance of the test pieces was evaluated by the following standard.

Excellent: No black spot contaminants having a major diameter of greater than 0.7 mm, no more than 5 black spot contaminants having a major diameter of greater than 0.5 mm and no greater than 0.7 mm, and no more than 10 black spot contaminants having a major diameter of greater than 0.3 mm and no greater than 0.5 mm

Good: No black spot contaminants having a major diameter of greater than 0.7 mm and no more than 5 black spot contaminants having a major diameter of greater than 0.5 mm and no greater than 0.7 mm, but more than 10 black spot contaminants having a major diameter of greater than 0.3 mm and no greater than 0.5 mm

Poor: One or more black spot contaminants having a major diameter of greater than 0.7 mm

(2) Polypropylene Resin Modifying Performance

Production process (A): Modified polypropylene having a polyphenylene ether resin content of 10 mass % was obtained through melt-kneading of an obtained pellet and homopolymer polypropylene having an MFR of 2.5 g/10 minutes as measured under conditions of a temperature of 230° C. and a load of 2.16 kg.

Production process (B): Modified polypropylene having exactly the same composition as in production process (A) was obtained through separate addition of a polyphenylene ether resin powder and a hydrogenated block copolymer, without using the pellet of the present embodiment.

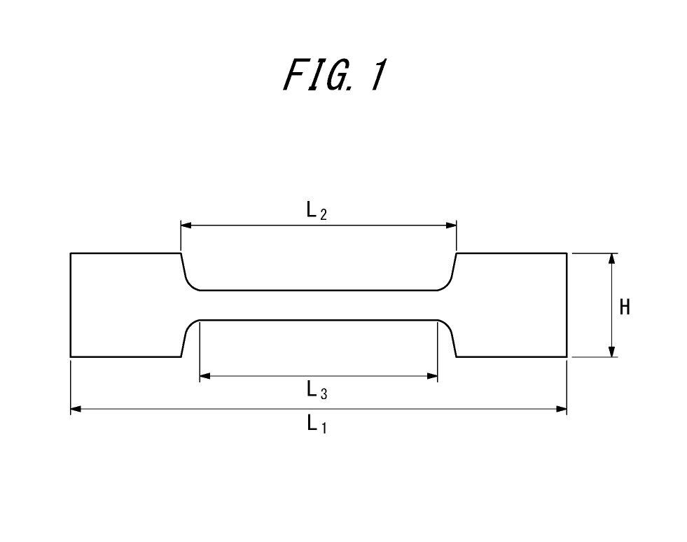

Pellets of the modified polypropylenes obtained in production processes (A) and (B) were each fed into a Ti-50G2 molding machine produced by Toyo Machinery & Metal Co., Ltd. that was set to a cylinder temperature of 245° C. and were molded under conditions of a mold temperature of 60° C. and an injection pressure of 65 MPa to obtain a test piece for creep measurement. The test piece for creep measurement was a dumbbell molded article (thickness: 1 mm) having a shape illustrated in FIG. 1. The test piece had a width L₁ of 65 mm, a width L₂ of 40 mm, a width L₃ of 22 mm, and a height H of 10 mm.

Creep was measured (thermal creep resistance test) with respect to the test piece for creep measurement using a creep tester (145-B-PC produced by Yasuda Seiki Seisakusho, Ltd.) under conditions of a chuck separation of 40 mm, a test load equivalent to a stress of 12.25 MPa, a test temperature of 80° C., and a test time of 165 hours. Thermal creep resistance (creep behavior) was evaluated based on strain [%] determined by the following formula. A smaller strain value indicates better creep behavior.

Strain [%]=(Displacement of test piece after 165 hours)/(Chuck separation)×100

(3) Productivity

In pellet production, the discharge amount per unit time (kg/h) from the extruder was recorded and this value was used as an index of production efficiency. A larger value indicates better production efficiency.

Moreover, during pellet production, the presence of molten resin composition spurting out from the atmospheric release vent (i.e., occurrence of vent-up) was checked. Safety in production and production efficiency were evaluated as excellent in cases in which vent-up did not occur.

The examples and comparative examples are described in detail below.

### Examples 1 to 15 and Comparative Examples 1 to 11

A twin screw extruder (TEM-58SS produced by Toshiba Machine Co., Ltd.) was used as a melt-kneading device for producing pellets in the examples and comparative examples. L/D of the extruder was 54.

The twin screw extruder included 13 barrels and had a screw configuration shown in Table 1. The meanings of symbols used to indicate the screw configuration in Table 1 are as follows.
Single flight: Pitch L/D=1.3
Double flight: Pitch L/D=1.3
R1: Kneading disc, right (L/D=1.0)
R2: Kneading disc, right (L/D=0.5)
L (compression-type): Kneading disc, left (L/D=0.5)
N (orthogonal-type): Kneading disc, neutral (L/D=1.0)

Pellets were obtained in the examples and comparative examples with the compositions and production conditions shown in Tables 2 and 3. Physical properties of the obtained pellets were measured by the previously described methods. The results of these measurements are shown in Tables 2 and 3.

TABLE 1

| | Screw configuration 1 | | Screw configuration 2 | | Screw configuration 3 | |
|---|---|---|---|---|---|---|
| Barrel 1 | Raw material | Single flight | Raw material | Single flight | Raw material | Single flight |
| | feeding/solid | | feeding/solid | | feeding/solid | |
| | conveyance | | conveyance | | conveyance | |
| | zone | | zone | | zone | |
| Barrel 2 | | | | | | |
| Barrel 3 | | Double | | Double | | Double |
| | | flight | | flight | | flight |
| Barrel 4 | | | | | | |
| Barrel 5 | | | | | | |
| Barrel 6 | | | | | | |
| Barrel 7 | First | R1, R2, N, | First | R1, R2, R1, | First | R1, R2, N, |
| | kneading | R2, N, R2 | kneading | R2, R1, R2 | kneading | L, R2 |
| | zone | | zone | | zone | |
| Barrel 8 | Atmospheric | Double | Atmospheric | Double | Atmospheric | Double |
| | release vent | flight | release vent | flight | release vent | flight |
| Barrel 9 | | | | | | |
| Barrel 10 | Second | R2, R2, N, | Second | R2, R2, N, | Second | R2, R2, N, |
| | kneading | L, R2 | kneading | L, R2 | kneading | L, R2 |
| | zone | | zone | | zone | |
| Barrel 11 | Vacuum vent | Double | Vacuum vent | Double | Vacuum vent | Double |
| | | flight | | flight | | flight |
| Barrel 12 | | | | | | |
| Barrel 13 | | | | | | |
| | Screw configuration 4 | | Screw configuration 5 | | Screw configuration 6 | |
| Barrel 1 | Raw material | Single flight | Raw material | Single flight | Raw material | Single flight |
| | feeding/solid | | feeding/solid | | feeding/solid | |
| | conveyance | | conveyance | | conveyance | |
| | zone | | zone | | zone | |
| Barrel 2 | | | | | | |
| Barrel 3 | | Double | | Double | | Double |
| | | flight | | flight | | flight |
| Barrel 4 | | | First | R1, R1, N, | | |
| | | | kneading | R, N, R2 | | |
| | | | zone | | | |
| Barrel 5 | | | Atmospheric | Double | | |
| | | | release vent | flight | | |
| Barrel 6 | | | | | | |
| Barrel 7 | First | R1, R2, N, | | | | |
| | kneading | R2, N, R2 | | | | |
| | zone | | | | | |
| Barrel 8 | | Double | | | | |
| | | flight | | | | |
| Barrel 9 | | | | | First | R1, R2, N, |
| | | | | | kneading | R2, N, R2 |
| | | | | | zone | |
| Barrel 10 | Second | R2, R2, N, | Second | R1, N, L | Atmospheric | Double |
| | kneading | L, R2 | kneading | | release vent | flight |
| | zone | | zone | | | |
| Barrel 11 | Vacuum vent | Double | Vacuum vent | Double | Second | R1, N, L |
| | | flight | | flight | kneading | |
| | | | | | zone | |
| Barrel 12 | | | | | Vacuum vent | Double |
| Barrel 13 | | | | | | flight |

TABLE 2

| | | | | Example 1 | Example 2 | Example 3 | Example 4 | Example 5 |
|---|---|---|---|---|---|---|---|---|
| Pellet | Component | Component (I-i) | Mass % | 80 | 90 | 95 | | |
| | (I) | Component (I-ii) | Mass % | | | | 80 | 90 |
| | Component | Component (II-i) | Mass % | 20 | 10 | 5 | 20 | 10 |
| | (II) | | | | | | | |
| Pellet | Screw configuration | | | 1 | 1 | 1 | 1 | 1 |
| production | Barrel | Barrel 1 | ° C. | 320 | 320 | 320 | 320 | 320 |
| process | temperature | Barrel 2 | ° C. | 320 | 320 | 320 | 320 | 320 |
| | | Barrel 3 | ° C. | 320 | 320 | 320 | 320 | 320 |
| | | Barrel 4 | ° C. | 320 | 320 | 320 | 320 | 320 |
| | | Barrel 5 | ° C. | 320 | 320 | 320 | 320 | 320 |
| | | Barrel 6 | ° C. | 320 | 320 | 320 | 320 | 320 |
| | | Barrel 7 | ° C. | 320 | 320 | 320 | 320 | 320 |
| | | Barrel 8 | ° C. | 320 | 320 | 320 | 320 | 320 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric release vent | | Yes/No | Yes | Yes | Yes | Yes | Yes |
| | Discharge amount | | kg/h | 250 | 250 | 250 | 300 | 300 |
| | Screw rotational speed | | rpm | 230 | 230 | 230 | 275 | 275 |
| | Oxygen concentration in furthest upstream collection | | Volume % | 0.5 | 0.5 | 0.5 | 0.5 | 0.5 |
| | hopper | | | | | | | |
| Evaluation | (1) Major | Major diameter of greater than 0.7 mm | No. | 0 | 0 | 0 | 0 | 0 |
| | diameter and | Major diameter of greater than 0.5 mm | No. | 0 | 0 | 1 | 0 | 0 |
| | number of | and no greater than 0.7 mm | | | | | | |
| | block spot | Major diameter of greater than 0.3 mm | No. | 3 | 4 | 5 | 2 | 2 |
| | contaminants | and no greater than 0.5 mm | | | | | | |
| | | Evaluation of external appearance | | Excellent | Excellent | Excellent | Excellent | Excellent |
| | (2) PP | Creep performance of modified PP: | Strain % | 11 | 7 | 6 | 11 | 7 |
| | modifying | Production process (A) | | | | | | |
| | performance | Creep performance of modified PP: | Strain % | 19 | 15 | 11 | 21 | 16 |
| | | Production process (B) | | | | | | |
| | (3) | Vent-up from atmospheric release | Yes/No | No | No | No | No | No |
| | Production | barrel | | | | | | |
| | stability | | | | | | | |
| | | | | | | | | Example |
| | | | | Example 6 | Example 7 | Example 8 | Example 9 | 10 |
| Pellet | Component | Component (I-i) | Mass % | | | | | |
| | (I) | Component (I-ii) | Mass % | 90 | 90 | 90 | 90 | 90 |
| | Component | Component (II-i) | Mass % | 10 | 10 | 10 | 10 | 10 |
| | (II) | | | | | | | |
| Pellet | Screw configuration | | | 1 | 1 | 1 | 2 | 4 |
| production | Barrel | Barrel 1 | ° C. | 320 | 320 | 320 | 320 | 320 |
| process | temperature | Barrel 2 | ° C. | 320 | 320 | 320 | 320 | 320 |
| | | Barrel 3 | ° C. | 320 | 320 | 320 | 320 | 320 |
| | | Barrel 4 | ° C. | 320 | 320 | 320 | 320 | 320 |
| | | Barrel 5 | ° C. | 320 | 320 | 320 | 320 | 320 |
| | | Barrel 6 | ° C. | 320 | 320 | 320 | 320 | 320 |
| | | Barrel 7 | ° C. | 320 | 320 | 320 | 320 | 320 |
| | | Barrel 8 | ° C. | 320 | 320 | 320 | 320 | 320 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric release vent | | Yes/No | No | Yes | Yes | Yes | — |
| | Discharge amount | | kg/h | 300 | 300 | 300 | 300 | 200 |
| | Screw rotational speed | | rpm | 275 | 275 | 275 | 275 | 185 |
| | Oxygen concentration in furthest upstream collection | | Volume % | 0.5 | 2.5 | 3.5 | 0.5 | 0.5 |
| | hopper | | | | | | | |
| Evaluation | (1) Major | Major diameter of greater than 0.7 mm | No. | 0 | 0 | 0 | 0 | 0 |
| | diameter and | Major diameter of greater than 0.5 mm | No. | 3 | 1 | 2 | 0 | 0 |
| | number of | and no greater than 0.7 mm | | | | | | |
| | block spot | Major diameter of greater than 0.3 mm | No. | 12 | 3 | 11 | 3 | 3 |
| | contaminants | and no greater than 0.5 mm | | | | | | |
| | | Evaluation of external appearance | | Good | Excellent | Good | Excellent | Excellent |
| | (2) PP | Creep performance of modified PP: | Strain % | 15 | 9 | 14 | 11 | 8 |
| | modifying | Production process (A) | | | | | | |
| | performance | Creep performance of modified PP: | Strain % | 16 | 16 | 16 | 16 | 16 |
| | | Production process (B) | | | | | | |
| | (3) | Vent-up from atmospheric release | Yes/No | No | No | No | Yes*¹⁾ | — |
| | Production | barrel | | | | | | |
| | stability | | | | | | | |
| | | | | Example | Example | Example | Example | Example |
| | | | | 11 | 12 | 13 | 14 | 15 |
| Pellet | Component | Component (I-i) | Mass % | | | | | |
| | (I) | Component (I-ii) | Mass % | 90 | 90 | 90 | 95 | 99 |
| | Component | Component (II-i) | Mass % | 10 | 10 | 10 | 5 | 1 |
| | (II) | | | | | | | |
| Pellet | Screw configuration | | | 5 | 1 | 1 | 1 | 1 |
| production | Barrel | Barrel 1 | ° C. | 320 | 290 | 320 | 320 | 320 |
| process | temperature | Barrel 2 | ° C. | 320 | 290 | 320 | 320 | 320 |
| | | Barrel 3 | ° C. | 320 | 290 | 320 | 320 | 320 |
| | | Barrel 4 | ° C. | 320 | 290 | 320 | 320 | 320 |
| | | Barrel 5 | ° C. | 320 | 290 | 320 | 320 | 320 |
| | | Barrel 6 | ° C. | 270 | 290 | 320 | 320 | 320 |
| | | Barrel 7 | ° C. | 270 | 290 | 320 | 320 | 320 |
| | | Barrel 8 | ° C. | 270 | 290 | 320 | 320 | 320 |
| | | Barrel 9 | ° C. | 270 | 270 | 270 | 270 | 270 |
| | | Barrel 10 | ° C. | 270 | 270 | 270 | 270 | 270 |
| | | Barrel 11 | ° C. | 270 | 270 | 270 | 270 | 270 |
| | | Barrel 12 | ° C. | 270 | 270 | 270 | 270 | 270 |
| | | Barrel 13 | ° C. | 270 | 270 | 270 | 270 | 270 |
| | Nitrogen flow to atmospheric release vent | | Yes/No | Yes | Yes | Yes | Yes | Yes |
| | Discharge amount | | kg/h | 300 | 300 | 325 | 300 | 275 |
| | Screw rotational speed | | rpm | 275 | 275 | 300 | 275 | 300 |
| | Oxygen concentration in furthest upstream collection | | Volume % | 0.5 | 0.5 | 0.5 | 0.5 | 0.5 |
| | hopper | | | | | | | |
| Evaluation | (1) Major | Major diameter of greater than 0.7 mm | No. | 0 | 0 | 0 | 0 | 0 |
| | diameter and | Major diameter of greater than 0.5 mm | No. | 1 | 0 | 0 | 0 | 3 |
| | number of | and no greater than 0.7 mm | | | | | | |
| | block spot | Major diameter of greater than 0.3 mm | No. | 4 | 5 | 2 | 4 | 6 |
| | contaminants | and no greater than 0.5 mm | | | | | | |
| | | Evaluation of external appearance | | Excellent | Excellent | Excellent | Excellent | Excellent |
| | (2) PP | Creep performance of modified PP: | Strain % | 13 | 9 | 8 | 6 | 5 |
| | modifying | Production process (A) | | | | | | |
| | performance | Creep performance of modified PP: | Strain % | 16 | 16 | 16 | 12 | 12 |
| | | Production process (B) | | | | | | |
| | (3) | Vent-up from atmospheric release | Yes/No | Yes*¹⁾ | Yes*¹⁾ | No | No | No |
| | Production | barrel | | | | | | |
| | stability | | | | | | | |

*¹⁾State in which unmelted PPE powder spurts out from opening

TABLE 3

| | | | | Comparative | Comparative | Comparative | Comparative |
|---|---|---|---|---|---|---|---|
| | | | | Example 1 | Example 2 | Example 3 | Example 4 |
| Pellet | Component (I) | Component (I-i) | Mass % | 75 | 99.5 | 90 | |
| | | Component (I-ii) | Mass % | | | | 75 |
| | Component | Component (II-i) | Mass % | 25 | 0.5 | | 25 |
| | (II) | Component (II-x) | Mass % | | | 10 | |
| Pellet | Screw configuration | | | 1 | 1 | 1 | 1 |
| production | Barrel | Barrel 1 | ° C. | 320 | 320 | 320 | 320 |
| process | temperature | Barrel 2 | ° C. | 320 | 320 | 320 | 320 |
| | | Barrel 3 | ° C. | 320 | 320 | 320 | 320 |
| | | Barrel 4 | ° C. | 320 | 320 | 320 | 320 |
| | | Barrel 5 | ° C. | 320 | 320 | 320 | 320 |
| | | Barrel 6 | ° C. | 320 | 320 | 320 | 320 |
| | | Barrel 7 | ° C. | 320 | 320 | 320 | 320 |
| | | Barrel 8 | ° C. | 320 | 320 | 320 | 320 |
| | | Barrel 9 | ° C. | 270 | 270 | 270 | 270 |
| | | Barrel 10 | ° C. | 270 | 270 | 270 | 270 |
| | | Barrel 11 | ° C. | 270 | 270 | 270 | 270 |
| | | Barrel 12 | ° C. | 270 | 270 | 270 | 270 |
| | | Barrel 13 | ° C. | 270 | 270 | 270 | 270 |
| | Nitrogen flow to atmospheric release vent | | Yes/No | Yes | Yes | Yes | Yes |
| | Discharge amount | | kg/h | 250 | 250 | 250 | 300 |
| | Screw rotational speed | | rpm | 230 | 230 | 230 | 275 |
| | Oxygen concentration in furthest upstream collection | | Volume % | 0.5 | 0.5 | 0.5 | 0.5 |
| | hopper | | | | | | |
| Evaluation | (1) Major | Major diameter of greater than 0.7 mm | No. | 0 | 6 | 0 | 0 |
| | diancter and | Major diameter of greater than 0.5 mm | No. | 0 | 13 | 0 | 0 |
| | number of | and no greater than 0.7 mm | | | | | |
| | block spot | Major diameter of greater than 0.3 mm | No. | 1 | 18 | 3 | 1 |
| | contaminants | and no greater than 0.5 mm | | | | | |
| | | Evaluation of external appearance | | Excellent | Poor | Excellent | Excellent |
| | (2) PP | Creep performance of modified PP: | Strain % | 20 | 7 | 14 | 24 |
| | modifying | Production process (A) | | | | | |
| | performance | Creep performance of modified PP: | Strain % | 45 | 4 | 21 | 51 |
| | | Production process (B) | | | | | |
| | (3) Production | Vent-up from atmospheric release | Yes/No | No | No | No | No |
| | stability | barrel | | | | | |
| | | | | Comparative | Comparative | Comparative | Comparative |
| | | | | Example 5 | Example 6 | Example 7 | Example 8 |
| Pellet | Component (I) | Component (I-i) | Mass % | | | | |
| | | Component (I-ii) | Mass % | 99.5 | 80 | 90 | 95 |
| | Component | Component (II-i) | Mass % | 0.5 | | | |
| | (II) | Component (II-x) | Mass % | | 20 | 10 | 5 |
| Pellet | Screw configuration | | | 1 | 1 | 1 | 1 |
| production | Barrel | Barrel 1 | ° C. | 320 | 320 | 320 | 320 |
| process | temperature | Barrel 2 | ° C. | 320 | 320 | 320 | 320 |
| | | Barrel 3 | ° C. | 320 | 320 | 320 | 320 |
| | | Barrel 4 | ° C. | 320 | 320 | 320 | 320 |
| | | Barrel 5 | ° C. | 320 | 320 | 320 | 320 |
| | | Barrel 6 | ° C. | 320 | 320 | 320 | 320 |
| | | Barrel 7 | ° C. | 320 | 320 | 320 | 320 |
| | | Barrel 8 | ° C. | 320 | 320 | 320 | 320 |
| | | Barrel 9 | ° C. | 270 | 270 | 270 | 270 |
| | | Barrel 10 | ° C. | 270 | 270 | 270 | 270 |
| | | Barrel 11 | ° C. | 270 | 270 | 270 | 270 |
| | | Barrel 12 | ° C. | 270 | 270 | 270 | 270 |
| | | Barrel 13 | ° C. | 270 | 270 | 270 | 270 |
| | Nitrogen flow to atmospheric release vent | | Yes/No | Yes | Yes | Yes | Yes |
| | Discharge amount | | kg/h | 300 | 300 | 300 | 300 |
| | Screw rotational speed | | rpm | 275 | 275 | 275 | 275 |
| | Oxygen concentration in furthest upstream collection | | Volume % | 0.5 | 0.5 | 0.5 | 0.5 |
| | hopper | | | | | | |
| Evaluation | (1) Major | Major diameter of greater than 0.7 mm | No. | 4 | 0 | 0 | 0 |
| | diancter and | Major diameter of greater than 0.5 mm | No. | 9 | 0 | 0 | 0 |
| | number of | and no greater than 0.7 mm | | | | | |
| | block spot | Major diameter of greater than 0.3 mm | No. | 13 | 2 | 3 | 3 |
| | contaminants | and no greater than 0.5 mm | | | | | |
| | | Evaluation of external appearance | | Poor | Excellent | Excellent | Excellent |
| | (2) PP | Creep performance of modified PP: | Strain % | 8 | 30 | 25 | 21 |
| | modifying | Production process (A) | | | | | |
| | performance | Creep performance of modified PP: | Strain % | 4 | 32 | 27 | 23 |
| | | Production process (B) | | | | | |
| | (3) Production | Vent-up from atmospheric release | Yes/No | No | No | No | No |
| | stability | barrel | | | | | |

| | | | | Comparative | Comparative | Comparative |
|---|---|---|---|---|---|---|
| | | | | Example 9 | Example 10 | Example 11 |
| Pellet | Component (I) | Component (I-i) | Mass % | | | |
| | | Component (I-ii) | Mass % | 90 | 90 | 90 |
| | Component | Component (II-i) | Mass % | 10 | 10 | 10 |
| | (II) | Component (II-x) | Mass % | | | |
| Pellet | Screw configuration | | | 3 | 3 | 6 |
| production | Barrel | Barrel 1 | ° C. | 320 | 320 | 320 |
| process | temperature | Barrel 2 | ° C. | 320 | 320 | 320 |
| | | Barrel 3 | ° C. | 320 | 320 | 320 |
| | | Barrel 4 | ° C. | 320 | 320 | 320 |
| | | Barrel 5 | ° C. | 320 | 320 | 320 |
| | | Barrel 6 | ° C. | 320 | 320 | 320 |
| | | Barrel 7 | ° C. | 320 | 320 | 320 |
| | | Barrel 8 | ° C. | 320 | 320 | 320 |
| | | Barrel 9 | ° C. | 270 | 270 | 320 |
| | | Barrel 10 | ° C. | 270 | 270 | 320 |
| | | Barrel 11 | ° C. | 270 | 270 | 270 |
| | | Barrel 12 | ° C. | 270 | 270 | 270 |
| | | Barrel 13 | ° C. | 270 | 270 | 270 |
| | Nitrogen flow to atmospheric release vent | | Yes/No | Yes | Yes | Yes |
| | Discharge amount | | kg/h | 200 | 300 | 300 |
| | Screw rotational speed | | rpm | 185 | 275 | 275 |
| | Oxygen concentration in furthest upstream collection | | Volume % | 0.5 | 0.5 | 0.5 |
| | hopper | | | | | |
| Evaluation | (1) Major | Major diameter of greater than 0.7 mm | No. | 1 | 5 | 3 |
| | diancter and | Major diameter of greater than 0.5 mm | No. | 3 | 9 | 8 |
| | number of | and no greater than 0.7 mm | | | | |
| | block spot | Major diameter of greater than 0.3 mm | No. | 4 | 12 | 14 |
| | contaminants | and no greater than 0.5 mm | | | | |
| | | Evaluation of external appearance | | Poor | Poor | Poor |
| | (2) PP | Creep performance of modified PP: | Strain % | 20 | 32 | 25 |
| | modifying | Production process (A) | | | | |
| | performance | Creep performance of modified PP: | Strain % | 16 | 16 | 16 |
| | | Production process (B) | | | | |
| | (3) Production | Vent-up from atmospheric release | Yes/No | No | No | No |
| | stability | barrel | | | | |

*¹⁾State in which unmelted PPE powder spurts out from opening

As shown in Tables 2 and 3, the pellets in Examples 1 to 15 had few black spot contaminants and excellent polyolefin resin modifying performance compared to the pellets in Comparative Examples 1 to 11.

In evaluation of polypropylene resin modifying performance, polypropylene modified using pellets by production process (A) had excellent creep resistance since a component that improved compatibility with the polypropylene was finely dispersed to a high degree in the pellets. On the other hand, the effect of improving creep resistance of polypropylene modified by production process (B) was poor due to insufficient dispersibility.

### INDUSTRIAL APPLICABILITY

According to the present disclosure, it is possible to provide a pellet that contains a polyphenylene ether resin in a high concentration, that is highly suitable for modifying a polyolefin resin by imparting creep resistance thereto, and that has excellent post-molding external appearance, and also to provide a process for producing this pellet.

1. A pellet comprising:
80 mass % to 99 mass % of a polyphenylene ether resin (I); and
1 mass % to 20 mass % of a hydrogenated block copolymer (II) that is an at least partially hydrogenated product of a block copolymer including a polymer block P of mainly a vinyl aromatic compound and a polymer block Q of mainly a conjugated diene compound in which the total of 1,2-vinyl bond content and 3,4-vinyl bond content is 50% to 95%, wherein
no black spot contaminants having a major diameter of greater than 0.7 mm are present on front and rear surfaces of four plates of 90.0 mm×50.0 mm×2.0 mm in size obtained through molding of the pellet.

2. The pellet of claim 1, wherein
the number of black spot contaminants having a major diameter of greater than 0.5 mm and no greater than 0.7 mm that are present on the front and rear surfaces of the four plates is no greater than 5.

3. The pellet of claim 1, wherein
the number of black spot contaminants having a major diameter of greater than 0.3 mm and no greater than 0.5 mm that are present on the front and rear surfaces of the four plates is no greater than 10.

4. The pellet of claim 1, comprising:
90 mass % to 99 mass % of the polyphenylene ether resin (I); and
1 mass % to 10 mass % of the hydrogenated block copolymer (II).

5. The pellet of claim 1, wherein
the polymer block P has a number average molecular weight of at least 15,000.

6. The pellet of claim 1, wherein
the total of 1,2-vinyl bond content and 3,4-vinyl bond content of the conjugated diene compound in the polymer block Q is 70% to 95%.

7. A process for producing a pellet, comprising
melt-kneading by a twin screw extruder of a mixture containing: 80 mass % to 99 mass % of a polyphenylene ether resin (I); and 1 mass % to 20 mass % of a hydrogenated block copolymer (II) that is an at least partially hydrogenated product of a block copolymer including a polymer block P of mainly a vinyl aromatic compound and a polymer block Q of mainly a conjugated diene compound in which the total of 1,2-vinyl bond content and 3,4-vinyl bond content is 50% to 95%, wherein
oxygen concentration inside a raw material feeding hopper that is furthest upstream in terms of a direction of mixture flow in the twin screw extruder is less than 3 volume %.

8. The process for producing a pellet of claim 7, wherein
the twin screw extruder includes:
a first kneading zone and a second kneading zone; and
at least two vents located either between the first kneading zone and the second kneading zone, or further downstream than the second kneading zone, and
at least one of the vents is an atmospheric release vent for gas venting.

9. The process for producing a pellet of claim 8, wherein
a screw of the first kneading zone includes at least one orthogonal screw element and does not include a compression screw element.

10. The process for producing a pellet of claim 8, wherein
a screw of the second kneading zone includes at least one compression screw element.

11. The process for producing a pellet of claim 8, wherein
the atmospheric release vent for gas venting is filled with an inert gas.

12. The process for producing a pellet of claim 8, wherein
a barrel temperature of at least 300° C. is set from a furthest upstream barrel in terms of the direction of mixture flow in the twin screw extruder, to a barrel at which the atmospheric release vent for gas venting is located.

13. A resin modifier comprising the pellet of claim 1.

14. A thermoplastic resin composition comprising the resin modifier of claim 13.
